(19) United States
(12) Patent Application Publication
(10) Pub. No.: US 2026/0343293 A1
(43) Pub. Date: Oct. 29, 2026

(54) TECHNIQUES FOR USER EQUIPMENT COOPERATION FOR IDLE-MODE MEASUREMENTS

(71) Applicant: QUALCOMM Incorporated, San Diego, CA (US)

(72) Inventors: Tommy AZZINO, Jersey City, NJ (US); Navid ABEDINI, Basking Ridge, NJ (US); Junyi LI, Greentown, PA (US); Xiaoxia ZHANG, San Diego, CA (US)

(21) Appl. No.: 19/188,692

(22) Filed: Apr. 24, 2025

(51) Int. Cl. H04W 24/10; H04W 24/08

(52) U.S. Cl. CPC H04W 24/10; H04W 24/08

(57) ABSTRACT

This disclosure provides methods, components, devices and systems for user equipment (UE) cooperation for idle-mode measurements. For example, a UE may receive a measurement configuration, such as from a network entity, that indicates one or more parameters for idle-mode measurements that are to be reported by the UE. The UE may obtain assistance from one or more other UEs of a group of cooperating UEs for logging, reporting, or both, of idle-mode measurements. A network entity that provides the measurement configuration may be unaware, or may be aware, of the collaboration or collocation of a group of UEs 115. A network entity that is aware of the group of cooperating UEs may provide a group-aware measurement configuration for logging idle-mode measurements, reporting of idle-mode measurements, or both. A network entity also may configure an accuracy requirement for positioning or localization of each UE for reporting of idle-mode measurements.

### TECHNICAL FIELD

This disclosure relates generally to wireless communication, and more specifically to systems, devices, methods, and techniques associated with techniques for user equipment cooperation for idle-mode measurements.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a first user equipment (UE) is described. The method may include receiving a measurement configuration for one or more idle mode measurements, the measurement configuration indicating one or more measurement parameters for the one or more idle mode measurements, communicating with one or more UEs of a set of multiple cooperating UEs to identify at least a second UE of the set of multiple cooperating UEs that will perform one or more of logging idle mode measurements or reporting idle mode measurements, and determining, based on the measurement configuration and the communication with the one or more UEs, to measure one or more instances of the one or more idle mode measurements, report one or more idle mode measurements of the second UE, or both.

A first UE for wireless communications is described. The first UE may include a processing system that includes processor circuitry and memory circuitry that stores code. The processing system may be configured to cause the first UE to receive a measurement configuration for one or more idle mode measurements, the measurement configuration indicating one or more measurement parameters for the one or more idle mode measurements, communicate with one or more UEs of a set of multiple cooperating UEs to identify at least a second UE of the set of multiple cooperating UEs that will perform one or more of logging idle mode measurements or reporting idle mode measurements, and determine, based on the measurement configuration and the communication with the one or more UEs, to measure one or more instances of the one or more idle mode measurements, report one or more idle mode measurements of the second UE, or both.

Another first UE for wireless communications is described. The first UE may include means for receiving a measurement configuration for one or more idle mode measurements, the measurement configuration indicating one or more measurement parameters for the one or more idle mode measurements, means for communicating with one or more UEs of a set of multiple cooperating UEs to identify at least a second UE of the set of multiple cooperating UEs that will perform one or more of logging idle mode measurements or reporting idle mode measurements, and means for determining, based on the measurement configuration and the communication with the one or more UEs, to measure one or more instances of the one or more idle mode measurements, report one or more idle mode measurements of the second UE, or both.

A non-transitory computer-readable medium storing code for wireless communications is described. The code may include instructions executable by one or more processors to receive a measurement configuration for one or more idle mode measurements, the measurement configuration indicating one or more measurement parameters for the one or more idle mode measurements, communicate with one or more UEs of a set of multiple cooperating UEs to identify at least a second UE of the set of multiple cooperating UEs that will perform one or more of logging idle mode measurements or reporting idle mode measurements, and determine, based on the measurement configuration and the communication with the one or more UEs, to measure one or more instances of the one or more idle mode measurements, report one or more idle mode measurements of the second UE, or both.

Some examples of the method, UEs, and non-transitory computer-readable medium described herein may further include operations, features, means, or instructions for determining to perform a subset of idle mode measurements of a set of two or more idle mode measurements indicated in the measurement configuration and measuring one or more parameters associated with the subset of idle mode measurements. Some examples of the method, UEs, and non-transitory computer-readable medium described herein may further include operations, features, means, or instructions for exchanging one or more messages with at least the second UE to determine which of the one or more idle mode measurements are to be performed at the first UE and which of the one or more idle mode measurements are to be performed at the second UE.

Some examples of the method, UEs, and non-transitory computer-readable medium described herein may further include operations, features, means, or instructions for transmitting a message to the second UE that delegates at least a first idle mode measurement of the one or more idle mode measurements to the second UE, receiving an indication of one or more measurement values from the second UE that is associated with the first idle mode measurement, and reporting the one or more measurement values from the second UE to a network entity.

In some examples of the method, UEs, and non-transitory computer-readable medium described herein, the measuring one or more instances of the one or more idle mode measurements may include operations, features, means, or instructions for measuring one or more values associated with the one or more idle mode measurements and transmitting the one or more values to the second UE for reporting to a network entity. Some examples of the method, UEs, and non-transitory computer-readable medium described herein may further include operations, features, means, or instructions for measuring one or more first values associated with the one or more idle mode measurements, transmitting the one or more first values to the second UE for storage, measuring one or more second values associated with the one or more idle mode measurements, retrieving the one or more first values from the second UE, and transmitting a measurement report that includes the one or more first values and the one or more second values.

Some examples of the method, UEs, and non-transitory computer-readable medium described herein may further include operations, features, means, or instructions for receiving positioning information from the second UE and determining a position associated with the first UE based on the positioning information from the second UE.

A method for wireless communications by a network entity is described. The method may include transmitting, to at least a first UE of a set of multiple cooperating UEs, a measurement configuration for one or more idle mode measurements, the measurement configuration indicating one or more measurement parameters for the one or more idle mode measurements and one or more UEs of the set of multiple cooperating UEs that are to perform the one or more idle mode measurements and receiving one or more measurement reports from one or more UEs of the set of multiple cooperating UEs in accordance with the measurement configuration.

A network entity for wireless communications is described. The network entity may include a processing system that includes processor circuitry and memory circuitry that stores code. The processing system may be configured to cause the network entity to transmit, to at least a first UE of a set of multiple cooperating UEs, a measurement configuration for one or more idle mode measurements, the measurement configuration indicating one or more measurement parameters for the one or more idle mode measurements and one or more UEs of the set of multiple cooperating UEs that are to perform the one or more idle mode measurements and receive one or more measurement reports from one or more UEs of the set of multiple cooperating UEs in accordance with the measurement configuration.

Another network entity for wireless communications is described. The network entity may include means for transmitting, to at least a first UE of a set of multiple cooperating UEs, a measurement configuration for one or more idle mode measurements, the measurement configuration indicating one or more measurement parameters for the one or more idle mode measurements and one or more UEs of the set of multiple cooperating UEs that are to perform the one or more idle mode measurements and means for receiving one or more measurement reports from one or more UEs of the set of multiple cooperating UEs in accordance with the measurement configuration.

A non-transitory computer-readable medium storing code for wireless communications is described. The code may include instructions executable by one or more processors to transmit, to at least a first UE of a set of multiple cooperating UEs, a measurement configuration for one or more idle mode measurements, the measurement configuration indicating one or more measurement parameters for the one or more idle mode measurements and one or more UEs of the set of multiple cooperating UEs that are to perform the one or more idle mode measurements and receive one or more measurement reports from one or more UEs of the set of multiple cooperating UEs in accordance with the measurement configuration.

In some examples of the method, network entities, and non-transitory computer-readable medium described herein, the one or more measurement reports include the one or more idle mode measurements of the set of multiple cooperating UEs and an indication of which UE of the set of multiple cooperating UEs performed the one or more idle mode measurements. In some examples of the method, network entities, and non-transitory computer-readable medium described herein, the measurement configuration further indicates whether the first UE can use information from one or more other UEs of the set of multiple cooperating UEs to provide the one or more idle mode measurements. In some examples of the method, network entities, and non-transitory computer-readable medium described herein, the measurement configuration further indicates which UE of the set of multiple cooperating UEs is to provide each idle mode measurement of the one or more idle mode measurements. In some examples of the method, network entities, and non-transitory computer-readable medium described herein, the measurement configuration may be a group common configuration that may be provided to each UE of the set of multiple cooperating UEs. In some examples of the method, network entities, and non-transitory computer-readable medium described herein, the measurement configuration may be a group-aware configuration provided to the first UE, and where the first UE provides the group-aware configuration to other UEs of the set of multiple cooperating UEs.

### BRIEF DESCRIPTION OF THE DRAWINGS

FIG. 1 shows an example of a wireless communication system.

FIG. 2 shows an example of a signaling configuration that supports user equipment (UE) cooperation for idle-mode measurements.

FIG. 3 shows another example of a signaling configuration that supports UE cooperation for idle-mode measurements.

FIG. 4 shows an example of a process flow that supports UE cooperation for idle-mode measurements.

FIG. 5 shows a block diagram of a processing system that supports UE cooperation for idle-mode measurements.

FIG. 6 shows a diagram of a system including a device that supports UE cooperation for idle-mode measurements.

FIG. 7 shows a block diagram of a processing system that supports UE cooperation for idle-mode measurements.

FIG. 8 shows a diagram of a system including a device that supports UE cooperation for idle-mode measurements.

FIGS. 9 through 16 show flowcharts illustrating methods that support techniques for UE cooperation for idle-mode measurements.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may be located in a relatively close vicinity of one or more other UEs. In some cases, the UEs may be located closely enough together to be considered as collocated, or having a same location for purposes of various network operations and wireless communications. In some cases, a group of collocated UEs may form a cooperation group, in which one or more tasks may be performed by one or more UEs, and shared among other UEs of the cooperation group. For example, a group of cooperating UEs may cooperate to perform different tasks, such as cell search and selection, system information acquisition, paging monitoring, or the like. UE cooperation may reduce workload and power consumption for any individual UE and improve overall performance for each of the cooperating UEs. For example, the group of cooperating UEs may elect a delegate or assisting UE which performs operations with the network (e.g., via a network entity) and shares results or information from the operations with the assisted UEs.

Further, one or more UEs may be in an idle or inactive state, and may be configured for idle-mode measurements that allows for collection of UE-specific measurements while the UE is in idle/inactive state. The UE can log or store its measurements and report them during a subsequent connection. Idle-mode measurements may associated with the various considerations or concerns, such as one or more of overhead of idle-mode measurement configuration, overhead of reporting idle-mode measurements, memory for storing the measurements at a UE, or power consumption of the UEs for performing the measurements (which may be exacerbated if a UE is configured to acquire its location to provide along with measurements).

Aspects of the subject matter described in this disclosure relate to performance of idle-mode measurements for UEs in a cooperation group. For example, a UE may receive a measurement configuration (e.g., from a network entity) that indicates one or more parameters for idle-mode measurements that are to be reported by the UE, and may obtain assistance from one or more other UEs of a group of cooperating UEs for logging, reporting, or both, of idle-mode measurements. In some aspects, UE coordination with the one or more other UEs may be transparent to a network entity that provides the measurement configuration, and a UE that receives the measurement configuration may provide a measurement report that is based on assistance from the one or more other UEs. In some aspects, a coordinating UE may delegate one or more measurements to another UE, receive the one or more measurements from the UE (e.g., via a sidelink connection, a Wi-Fi connection, a Bluetooth connection, or any other device-to-device communication link), and provide the one or more measurements in a measurement report. In some aspects, a coordinating UE may perform one or more measurements and provide the measurements to a second UE of the cooperation group for storage, and obtain the stored measurements from the second UE when preparing the measurement report for transmission. In some aspects, an indication may be provided with the measurement report to indicate that one or more measurements were obtained from different UEs in a cooperation group.

Additionally, or alternatively, a network entity that provides the measurement configuration may be aware of the collaboration or collocation of a group of UEs, and may provide a group-aware measurement configuration for logging idle-mode measurements, reporting of idle-mode measurements, or both. In some aspects, the network entity may provide an indication of which UEs of the group are to perform certain measurements, which UEs of the group are to report measurements, or both. In some aspects, the network entity may provide a legacy configuration (e.g., that indicates a time window T and periodicity-based or event-based logging) and let the cooperating UEs determine how to collectively provide a measurement report based on the measurement configuration. In some aspects, the network entity may configure different types of reporting for the logged measurements, such as combined reporting of measurements of different UEs by one UE of the group of UEs, reporting of statistics associated with one or more measurement parameters, reporting of which UEs have measurements that are available, reporting of differences from one or more measurements, or any combination thereof. Additionally, or alternatively, the network entity may configure an accuracy requirement for the positioning or localization of each UE for reporting of idle-mode measurements.

Particular aspects of the subject matter described in this disclosure can be implemented to realize one or more of the following potential advantages. In some examples, by obtaining assistance from one or more other UEs of a group of cooperating UEs for logging, reporting, or both, of idle-mode measurements, the described techniques can be used to reduce overhead associated with multiple reports from multiple UEs, and also reduce power consumption and usage of processing resources at UEs. Additionally, by providing storage of measurements at different UEs, the described techniques can be used to reduce storage associated with idle-mode measurements at UEs while providing sufficient information for complete measurement reports. Further, by providing a group-aware measurement configuration, a network entity may efficiently configure idle-mode measurements across multiple UEs, which may enhance network efficiency and provide for accurate measurement reports that may be used for network operational decisions.

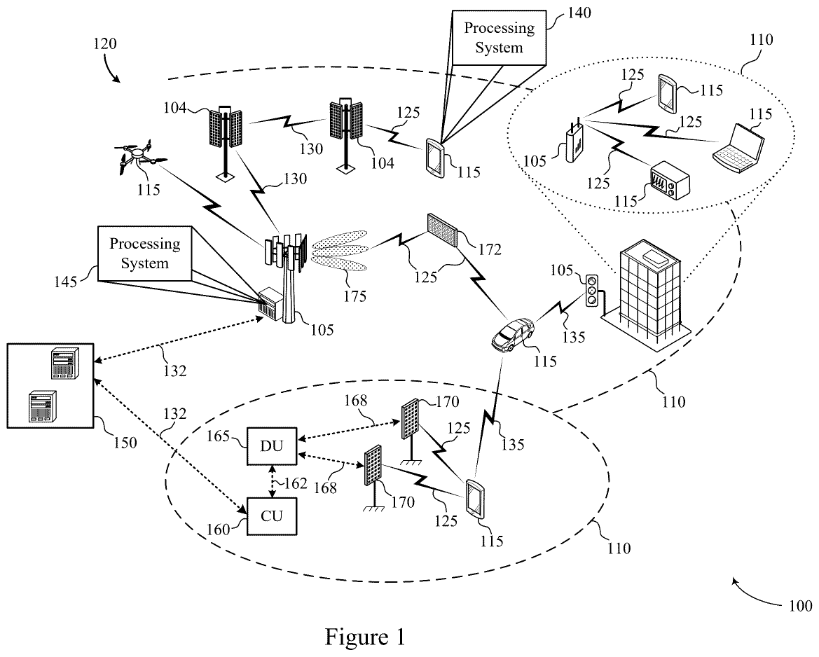

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR 1), between 425 MHz and 7.125 GHz), a mid-band (such as Frequency Range 3 (FR 3), between 7.125 GHz and 24.25 GHz), or an upper frequency band (such as Frequency Range 2 (FR 2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

UE cooperation may enable energy-efficient operation, capacity improvements, and coverage improvements. UEs 115 may cooperate to accomplish tasks such as one or more of cell search, cell selection, cell reselection, system information acquisition, paging monitoring, measurement reporting, or the like. UE cooperation techniques may reduce workload for any individual UE 115 and improve overall performance for each of the cooperating UEs 115.

In accordance with various aspects, devices of the wireless communication system 100 may be configured to support one or more aspects of the described techniques for UE cooperation for idle-mode measurements. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support performance of one or more idle-mode measurements by different UEs of a cooperating group of UEs, which may reduce power consumption, processing resource usage, and storage of idle-mode measurements, at one or more of the UEs of the cooperating group of UEs.

In some cases, a group of cooperating UEs 115 may be selected through local wireless signaling between cooperating UEs 115 that are collocated (e.g., within a relatively close distance). Additionally, or alternatively, a group of cooperating UEs 115 may be selected in a centralized manner, such as by being selected by a network entity 105 or a separate entity, such as a third-party application.

In some cases, metrics used as criteria for selecting UEs 115 of a group of cooperating UEs 115 may change over time. For example, one UE 115 of the cooperating UEs 115 may experience changing radio conditions or may move away from the group of cooperating UEs 115 over time. If, for example, conditions change such that a UE 115 currently operating in the group of cooperating UEs 115 is no longer considered to be collocated, the group of cooperating UEs 115 may be modified to remove such a UE 115.

In some aspects, a UE 115 may receive a measurement configuration (e.g., from a network entity 105) that indicates one or more parameters for idle-mode measurements that are to be reported by the UE 115, and may obtain assistance from one or more other UEs 115 of the group of cooperating UEs 115 for logging, reporting, or both, of idle-mode measurements. In some aspects, a network entity 105 that provides the measurement configuration may be aware of the collaboration or collocation of a group of UEs 115, and may provide a group-aware measurement configuration for logging idle-mode measurements, reporting of idle-mode measurements, or both. In some aspects, the network entity 105 may configure different types of reporting for the logged measurements, such as combined reporting of measurements of different UEs 115 by one UE 115 of the group of UEs 115, reporting of statistics associated with one or more measurement parameters, reporting of which UEs 115 have measurements that are available, reporting of differences from one or more measurements, or any combination thereof. Additionally, or alternatively, the network entity 105 may configure an accuracy requirement for the positioning or localization of each UE 115 for reporting of idle-mode measurements.

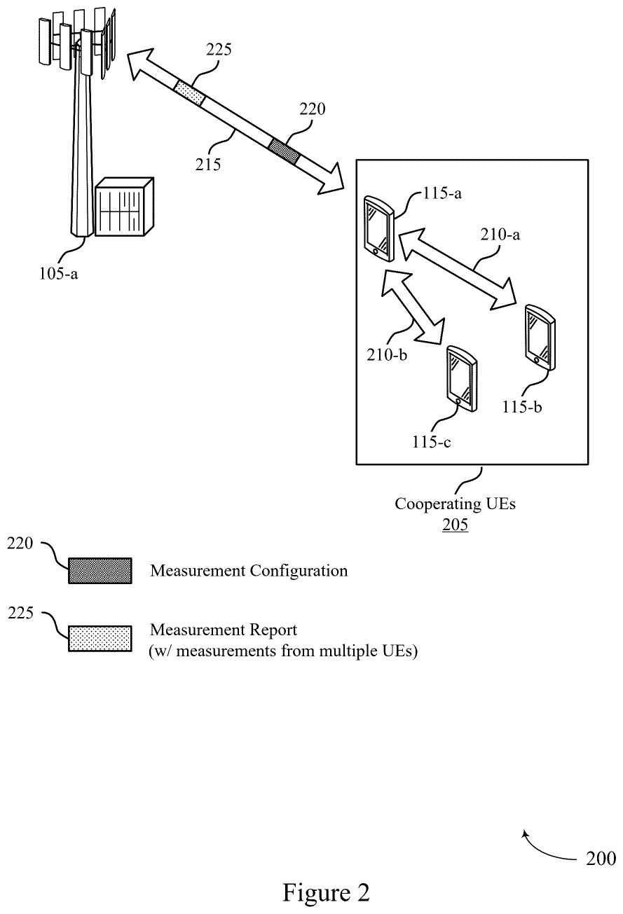

FIG. 2 shows an example of a signaling configuration 200 that supports UE cooperation for idle-mode measurements. The signaling configuration 200 may include a network entity 105-a and a group of cooperating UEs 205. The network entity 105-a may be an example of a network entity 105 as described herein. The group of cooperating UEs 205 may include multiple UEs 115, such as a first UE 115-a, a second UE 115-b, and a third UE 115-c, each of which may be an example of a UE 115 as described herein.

The cooperating UEs 205 may perform techniques for UE cooperation for idle-mode measurements. In some examples, the UEs 115 may perform coordination communications to establish the group of cooperating UEs 205. Such coordination communications may be via device-to-device links 210 via any suitable device-to-device signaling (e.g., sidelink communications, Wi-Fi communications, Bluetooth communications, etc.). In some cases, a first UE 115-a may be selected as an assisting UE 115 from the cooperating UEs 205 to perform operations with a network, for example via the network entity 105-a, and share results or measurement information from the other cooperating UEs 115. For example, the first UE 115-a may obtain a measurement configuration 220 from the network entity 105-a via communication link 215, and coordinate with the other cooperating UEs 115 to determine which UEs 115 should perform certain measurements, which UEs 115 should provide a measurement report 225 to the network entity 105-a (e.g., via communication link 215), or both. For example, one or more of the cooperating UEs 115, such as the first UE 115-a, may evaluate metrics for each of the cooperating UEs, such as a second UE 115-b and a third UE 115-c, to determine which of the cooperating UEs is to provide measurements associated with one or more measurement parameters indicated in the measurement configuration 220. Additionally, or alternatively, the UE(s) 115 to provide certain measurements may be selected in a centralized manner, such as discussed with reference to FIG. 2 herein, in which the network entity 105-a (or another network node, or a third-party entity such as third-party application) may select one or more UEs 115 for one or more idle-mode measurements.

In accordance with various aspects, idle-mode measurements of multiple UEs 115 may be provided in one or more measurement reports 225. Idle-mode measurement is a functionality that allows collection of UE-specific measurements using a Control Plane architecture which may be used for network evaluation and operations (such as, for example, for Logged Minimization of Drive Test (MDT) techniques). While idle or inactive, one or more of the UEs 115 may log measurements (e.g., reference signal receive power (RSRP), reference signal receive quality (RSRQ), a synchronization signal block (SSB) index of one or more measurements, or the like) from a current camping cell or, if configured, one or more neighboring cells, or both. When such a UE 115 transitions to a radio resource control (RRC) connected state, it may report logged idle-mode measurements. For example, the network entity 105-a may initiate the procedure with the first UE 115-a when the first UE 115-a is in a RRC-connected mode by sending measurement configuration 220 (e.g., an RRC LoggedMeasurementConfiguration message), which may be used by the first UE 115-a to acquire parameters for carrying the measurements and future reporting. Such a configuration may include one or more of, for example, a configuration of downlink pilot strength measurements, triggering of logging events (e.g., event-based or periodic), configuration of logging duration (e.g., in which a timer is used to indicate a window duration triggered measurements, and is started upon reception of the configuration message), configuration of a logging area, or configuration of a list of neighboring cells and/or frequencies to include in the measurements report. In some cases, logging may continue until a UE memory reserved for idle-mode measurements is full. In some cases, when a LoggedMeasurementConfiguration message is received, timer for reporting may be initiated (e.g., a 48 hour timer), and if the network entity 105-a does not collect measurements prior to expiration of the timer, the logged measurements may be discarded.

In some cases, a UE 115 (e.g., the first UE 115-a) may indicates the availability of logged measurements using one bit when switching to RRC-connected mode (e.g., during a connection establishment procedure), and the UE 115 may be asked to send the collected measurements via RRC signaling (e.g., via an RRC UEInformationRequest/UEInformationResponse message). In some cases, the collected measurements may include a timestamp and location information, where the location information may be detailed (e.g., global navigation satellite system (GNSS) location information, if available) or coarse (e.g., RF fingerprints from different cells), and sensor information might be included if available at the UE 115. Thus, UE 115 measurement logs may include multiple events and measurements taken over time, where the time interval for measurement collection and reporting may be decoupled to limit the impact on the UE 115 battery consumption and network signaling load. In some cases, the network entity 105-a may use UE 115 capabilities to select UEs 115 for idle-mode measurements. In some cases, to limit the impact on UE 115 power consumption and processing, the UE 115 measurement logging may rely on measurements that are available at the UE 115, and detailed location information configuration may consider power consumption of the UE 115 due to operation of positioning components.

In accordance with various aspects, the group of cooperating UEs 205 (e.g., which may or may not be associated with a same user, but may be associated with a same public land mobile network (PLMN)) may be, at least temporarily, collocated and/or moving together. For example, the group of cooperating UEs 205 may be in a same vehicle, or in a same room or structure, such that their distance from each other does not exceed a certain threshold (e.g., δPOS, which may be configurable). As discussed herein, this group of cooperating UEs 205 may form a cooperation group to perform idle-mode measurements. As also discussed, in some traditional cases, each UE 115 may acquire a measurement configuration 220 while in connected mode and then, after collecting the measurements, each UE 115 may inform the network entity 105-a and send a measurement report. Such reporting for each UE 115 of multiple collocated UEs 115, such as UEs 115 of the group of cooperating UEs 205, may be inefficient with respect to signaling overhead of measurement configuration and reporting, and energy efficiency for the UEs 115 and the network entity 105-a. In addition, each UE 115, before performing measurements logging, and again to report logged measurements, would transition to a connected state with the network entity 105-a. Various techniques as discussed herein may help to reduce transmission of redundant information and thereby reduce overhead associated with idle-mode measurements (e.g., through reduced configuration overhead, reduced measurement reporting overhead, or both), reduce power consumption, and provide for additional logged measurements across multiple UEs 115 through distributed storage of logged measurements.

As discussed, in some aspects, coordination among UEs 115 of the group of cooperating UEs 205 may be transparent to the network entity 105-a. In such aspects, the first UE 115-a may receive measurement configuration 220 from the network entity 105-a, and is assisted by other UEs 115 of the group of cooperating UEs 205 for the logging, reporting, or both, of idle-mode measurements. In some aspects, upon reception of the measurement configuration 220, the first UE 115-a may delegate or divide the workload among other UEs 115 of the group of cooperating UEs 205 (e.g., among the second UE 115-b and the third UE 115-c). In some aspects, the other UEs 115 of the group of cooperating UEs 205 may provide assistance to the first UE 115-a in the form of actual measurements, positioning information, or both. In some cases, the first UE 115-a may divide the configured measurements among the group of cooperating UEs 205. For example, in the case of periodic logging of measurements over a window with duration T, the first UE 115-a may delegate a first subset of measurements for a first portion of the window to the second UE 115-b and a second subset of measurements for a second portion of the window to the third UE 115-c. The coordination between the UEs 115 of the group of cooperating UEs 205 may use local signaling via device-to-device links 210 (e.g., first device-to-device link 210-a and second device-to-device link 210-b).

In some aspects, cooperating UEs 115 of the group of cooperating UEs 205 can also help storing certain measurements (e.g., without logging actual measurements themselves) so that the first UE 115-a may collect more measurements or reduce memory consumption of memory allocated for idle-mode measurement logging. For reporting, the first UE 115-a may re-collect the logged measurements from collaborating UEs, or each collaborating UE 115 may report the first UE 115-a measurements to the network entity 105-a (e.g. based on an indication provided by the first UE 115-a that other UEs 115 of the group of cooperating UEs 205 have logged measurements stored). Additionally, or alternatively, cooperating UEs 115 (e.g., second UE 115-b and third UE 115-c) may help the first UE 115-a perform accurate positioning, which may help the first UE 115-a to reduce power consumption during idle-mode measurements.

In some aspects, the first UE 115-a may indicate the reported measurements are from collaboration in the measurement report 225 (e.g., by providing an indication in a field of the measurement report 225 associated with collaboration that may indicate one or more of whether collaboration was used, an identity of one or more UEs 115 that performed measurements, or which measurements are from other UEs 115). In some aspects, the network entity 105-a may obtain the measurement report 225 and indication of use of collaboration for one or more measurements, and determine how to use this information and, if needed, prevent or allow the first UE 115-a from using collaboration for idle-mode measurements. Additionally, or alternatively, the network entity 105-a may can prevent or allow the first UE 115-a from using collaboration when sending the measurement configuration (e.g., based on a capability indication of the first UE 115-a of support for collaboration for idle-mode measurements).

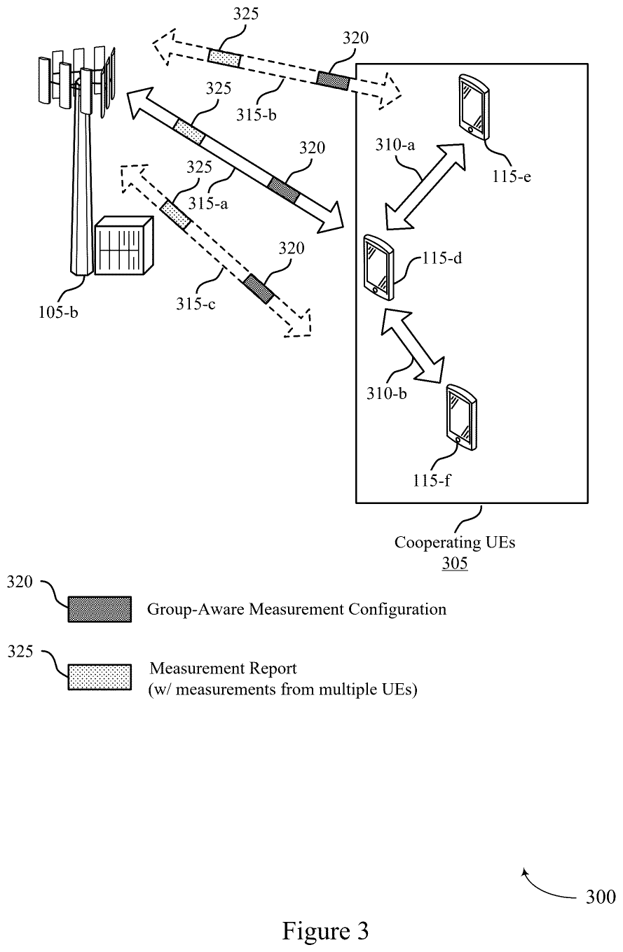

FIG. 3 shows an example of a signaling configuration 300 that supports UE cooperation for idle-mode measurements. The signaling configuration 300 may include a network entity 105-c and a group of cooperating UEs 305. The network entity 105-b may be an example of a network entity 105 as described herein. The group of cooperating UEs 305 may include multiple UEs 115, such as a first UE 115-d, a second UE 115-e, and a third UE 115-f, each of which may be an example of a UE 115 as described herein.

The cooperating UEs 305 may perform techniques for UE cooperation for idle-mode measurements. In the example of FIG. 3, the network entity 105-b may be aware of the group of cooperating UEs 305 for idle-mode measurements. In some examples, the UEs 115 may perform coordination communications to establish the group of cooperating UEs 305, and provide an indication of the group of cooperating UEs 305 to the network entity 105-b. Such coordination communications may be via device-to-device links 310 via any suitable device-to-device signaling (e.g., sidelink communications, Wi-Fi communications, Bluetooth communications, etc.). In some examples, the network entity 105-b may transmit a group-aware measurement configuration 320 to one or more UEs 115 of the group of cooperating UEs 305. For example, the network entity 105-a may transmit the group-aware measurement configuration 320 to the first UE 115-d via a first link 315-a, and optionally may transmit the group-aware measurement configuration 320 to one or both of the second UE 115-e via second link 315-b or the third UE 115-f via third link 315-c. In some cases, the first UE 115-d may coordinate with the other cooperating UEs 115 to perform certain measurements, which one or more of the UEs 115 may provide in a measurement report 325 to the network entity 105-a (e.g., via a respective communication link 315). For example, one or more of the cooperating UEs 115, such as the first UE 115-d, may evaluate metrics for each of the cooperating UEs, such as second UE 115-e and third UE 115-f, to determine which of the cooperating UEs 115 is to provide measurements associated with one or more measurement parameters indicated in the group-aware measurement configuration 320. Additionally, or alternatively, the UE(s) 115 to provide certain measurements may be selected in a centralized manner and indicated in the group-aware measurement configuration 320, in which the network entity 105-a (or another network node, or a third-party entity such as third-party application) may select one or more UEs 115 for logging and/or reporting of one or more idle-mode measurements in one or more measurement reports 325.

In some aspects, the network entity 105-b may have previous knowledge or context regarding the group of cooperating UEs 305. In some aspects, UEs 115 may have been previously configured individually for idle-mode measurements and may later form the group of cooperating UEs 305, and may notify the network entity 105-b about the formed group. In other aspects, the network entity 105-b may be aware that the first UE 115-d may be able to obtain assistance from other UEs 115 for performing idle-mode measurements without having prior knowledge about other UEs. In either case, the network entity 105-b may share the group-aware measurement configuration 320. In some cases, the network entity 105-b, based on its knowledge of the cooperating UEs 115, may determine a measurement configuration for each individual UE 115, or for the whole group. In some aspects, a group-common configuration may be provided (e.g., a same or common configuration for all UEs 115 in the group of cooperating UEs 305) as a special case of a group-aware measurement configuration 320. In some aspects, the network entity 105-b may share the group-aware measurement configuration 320 with the first UE 115-d, which may in turn will share it with the second UE 115-e and the third UE 115-f (and/or one or more other UEs in the group of cooperating UEs 305), which may reduce overhead associated with measurement configuration. In other aspects, the network entity 105-b may transmit the group-aware measurement configuration 320 to all UEs 115 of the group of cooperating UEs 305 via a multicast or broadcast channel on links 315.

As discussed, in some aspects the network entity 105-b may determine a split of measurements, logging, or both, for idle-mode measurements for the group of cooperating UEs 305. For example, for periodic measurement logging during a time window T, each UE 115 may be configured with a different periodicity (P) and different offset (O) from the starting time of logging. In such a manner, the logs of each UE 115 may not overlap in time. In some examples, UEs 115 can be configured with different periodicities and/or offsets based on their capabilities. In another example, the UEs 115 may be time-division multiplexed (TDMed) over a time window T such that each UE 115 may perform logging for a duration (T/N), where N is a total number of cooperating UEs 115 or a subset of UEs 115 of the group of cooperating UEs 305. In some cases, P, O, or N may be configured by the network entity 105-b to reduce logging for each individual UE 115, hence reducing power consumption (e.g., through less localization events at each UE 115) and improving memory utilization at each UE 115. In cases where the group-aware measurement configuration 320 provides for event-triggered logging, each UE 115 may be configured to monitor one specific event or a subset of events.

In other aspects, the network entity 105-b may adopt a group-aware measurement configuration 320 (e.g., given by time window T and periodicity-based or event-based logging) and let the cooperating UEs 115 of the group of cooperating UEs 305 determine how to collectively achieve the requested measurements. In some cases, the network entity 105-b may provide some specific requirements for the logging. For example, the network entity 105-b may specify a distance threshold (e.g., δPOS) for the purpose of logging, and the UEs 115 may cooperate for idle-mode measurements collection if they satisfy this condition. In another example, the network entity 105-b may specify a measurement threshold (e.g., δMEAS), for the purpose of logging. For example, the measurement can be RSRP, and the measurement threshold and measurement itself can refer to RSRP of the associated network communication link 315 or the RSRP of the associated device-to-device links 310 (e.g., first device-to-device link 310-a and second device-to-device link 310-b). In some cases, the network entity 105-b may indicate that one sample is to be used to make the collaboration decision, or may configure an observation window such that if metrics are within the considered threshold for all samples in the observation window (or a percentage X% of them) then the condition is met for cooperative idle-mode measurements.

In some aspects, the network entity 105-b may create a new group-specific configuration for the group-aware measurement configuration 320. For example, the network entity 105-b may specify that the group of cooperating UEs 305 is to report a statistic on one or more computed measurements per timestamp (e.g., UEs 115 may statically combine their measurements to report mean, range, percentiles, and/or variance, instead of the full list of measurements). In some examples, the combination of measurements in certain statistics may hold in specific circumstances configured by the network entity 105-b, such as if a difference in the measured quantity is within a certain threshold (e.g., δMEAS), or a specific distance threshold (e.g., δPOS) can be configured. Such techniques may reduce the overhead associated with later reporting of the logged measurements, through combined measurements instead of individual measurements from each UE 115. In some cases, if any configured circumstance is not met, the related measurements may be logged, reported, or both, individually (e.g., the measurements do not contribute to any statistics).

In some aspects, among the group of cooperating UEs 305, one or more of the UEs 115 may be identified as being a better UE 115 for conducting idle-mode measurements. For example, criteria for such a selection may include one or more of whether a UE 115 might have better signal strength than another UE 115 (e.g., a UE 115 that is located closer to a window in a building or vehicle), whether a UE 115 might have less relative movement and experiences less Doppler (hence can provide more stable measurements) or whether a UE 115 might have better implementation and provide more accurate measurements. In some cases, a better UE may be more desirable for performing idle-mode measurements. In other cases, the network entity 105-b may desire to see a difference or spread within the measurements of the group of cooperating UEs 305. In some aspects, the network entity 105-b may indicate whether better UEs 115 can be considered or not when sending the group measurement configuration. In some cases, in the measurement reporting phase, a reporting UE 115 may indicate to the network entity 105-b (e.g. in the measurement report 325) UEs 115 within the group of cooperating UEs 305 contributed to the reported measurements. Further, in some examples, the reporting UE 115 may indicate an amount of time each UE 115 contributed to the reported measurements.

Additionally, or alternatively, situations might arise where collaboration for idle-mode measurements are interrupted. For example, the collocation of the group of cooperating UEs 305 might end (e.g., due to UEs 115 taking different routes or UEs 115 not meeting one or more configured thresholds for collaboration). In some cases, the network entity 105-b may set up two measurement configurations, one group-aware and the other one UE-specific, and a UE 115 knows that, if collaboration is broken, it should resort on the UE-specific measurement configuration. In other cases, a UE 115 may re-register with the network entity 105-b, which may provide the UE-specific measurement configuration.

In some further aspects, additionally, or alternatively, the network entity 105-b may configure different types of reporting for logged measurements as follows. For example, the network entity 105-b may configure individual reporting for each UE 115, combined reporting in which one UE 115 (e.g., the first UE 115-d) collects individual measurements from each collaborating UE 115 (e.g., the second UE 115-e and the third UE 115-f) and sends them in a single measurement report 325 as a unique list of logged measurements. The different types of reporting may also include combined statistics reporting, in which one UE 115 may compute measured statistics and report them in the measurement report 325. In further examples, the different types of reporting may include an indication of availability of measurements for one or more other UEs 115 of the group of cooperating UEs 305, and the network entity 105-b may determine whether to request measurements from the other UEs 115. Further, a combination of different types of reporting also may be utilized. Additionally, in some cases, the network entity 105-b may configure different modes for logging and/or reporting based on a specific area or timing advance (TA) associated with UEs 115 of the group of cooperating UEs 305. For example, the network entity 105-b might desire more measurements for a certain area compared to other areas.

With respect to values provided in the measurement report 325, in some aspects a UE 115 may report a delta measurement with respect to one of the other UEs. Such reporting may further reduce overhead, as fewer bits may be needed to encode a difference value, since UEs are collocated their difference in measurements may be expected to be relatively small. For example, a UE 115 that is relatively stationary can report a first measurement (or any other representative measurement) and for subsequent measurements the delta difference may be reported against the first measurement. Further, such techniques may be applied in the logging phase of a UE 115 as well, hence saving memory for logging.

In some further aspects, positioning enhancements for idle-mode measurements of the group of cooperating UEs 305 may be provided. In some examples, the network entity 105-b may configure an accuracy target for positioning or localization of each UE 115. For example, the first UE 115-d may leverage the second UE 115-e acquired location if the first UE 115-d it is within a certain range from the second UE 115-e, where the range may be configured by the network entity 105-b (e.g., based on a δPOS). In other examples, each UE 115 may report their level of accuracy for positioning events (e.g., as additional data in the measurement report 325), and the network entity 105-b may determine whether certain UEs 115 can leverage the localization provided by other UEs 115. Further, the network entity 105-b may determine whether to discard the associated measurements if the localization accuracy is low. In each case, power consumption from the localization component for the cooperating UEs may be reduced. Additionally, or alternatively, collaborating UEs 115 may report their delta location (e.g., positioning coordinates) with respect to one of the other UEs 115. For example, N1 bits may be used to encode a delta location (e.g., due to UEs 115 being collocated, their difference in location should be relatively small), compared to N2 bits to encode full position information, where N2>N11. Additionally, if a UE 115 is relatively stationary, it can report a first (or most representative) location measurement and a location delta against this measure for subsequent localizations. Such location delta information may reduce reporting overhead as well as memory required for logging.

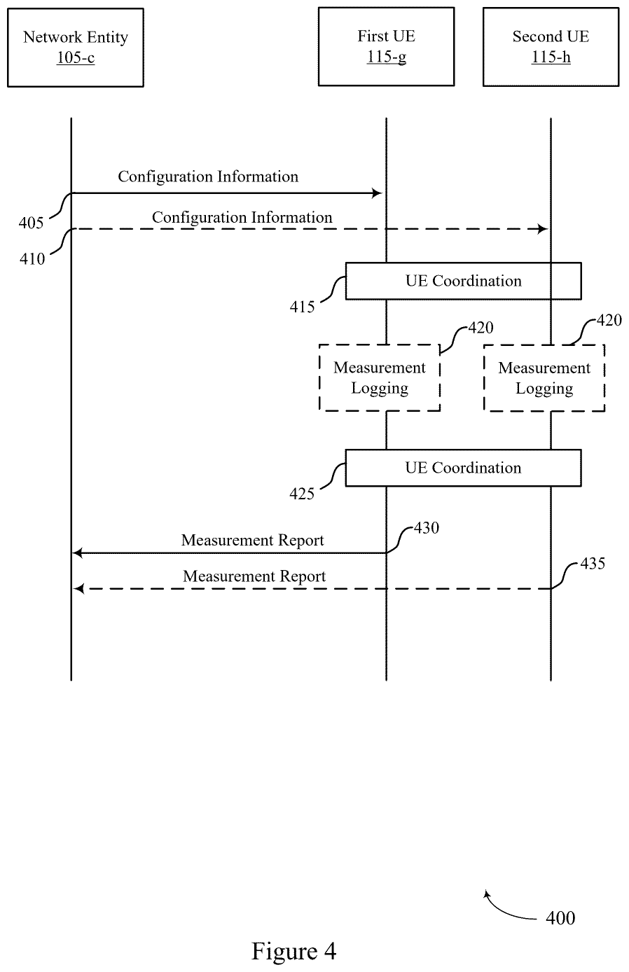

FIG. 4 shows an example of a process flow 400 that supports UE cooperation for idle-mode measurements. The process flow 400 may implement, or be implemented by, aspects of the wireless communications system 100, the signaling configuration 200, the signaling configuration 300, or any combination thereof.

For example, the process flow 400 may illustrate a communications flow or call flow between a first UE 115-g, a second UE 115-h, and a network entity 105-c, which may be examples of the corresponding devices as described with reference to FIG. 1-3. For example, the first UE 115-g and the second UE 115-h may be UEs 115 participating in UE cooperation to report idle-mode measurements to network entity 105-c (or a third-party control entity).

In some examples, at 405, the network entity 105-c may transmit, and the first UE 115-g may receive, configuration information. In some examples, the configuration information may include an idle-mode measurement configuration for idle-mode measurements of the first UE 115-g, or may include a group-aware measurement configuration for idle-mode measurements of a group of cooperating UEs, as discussed herein. Optionally, at 410, the network entity 105-c may transmit, and the second UE 115-h may receive, the configuration information (e.g., via a separate communication link with the second UE 115-h or via a broadcast or groupcast transmission). In some examples, the configuration information may indicate which UEs 115 of a group of cooperating UEs 115 are to perform certain measurements, or may indicate that one or more of the UEs 115 are to determine how to divide measurements.

At 415, the first UE 115-g and the second UE 115-h may perform UE coordination, in which the measurement configuration may be shared among UEs 115, or specific UEs 115 selected for certain measurements (e.g., certain time periods during which different UEs 115 are to log measurements, as discussed herein). At 420, one or both of the first UE 115-g and the second UE 115-h may perform measurement logging, in accordance with logging techniques as discussed herein. At 425, the first UE 115-g and the second UE 115-h may perform UE coordination, in which one or more logged measurements may be shared for storage, for reporting, or both.

At 430, the first UE 115-g may transmit, and the network entity 105-c may receive, a measurement report that indicates the one or more idle-mode measurements of the group of cooperating UEs 115. The measurement report may include idle-mode measurements in accordance with various reporting techniques as discussed herein. Optionally, at 435, the second UE 115-h may transmit, and the network entity 105-c may receive, a measurement report that indicates the one or more idle-mode measurements of the group of cooperating UEs 115. As discussed herein, in some cases one or multiple UEs 115 may provide all or a portion of idle-mode measurements in accordance with an idle-mode measurement configuration. In some cases, the second UE 115-h may transmit the measurement report in response to a query from the network entity 105-c (e.g., based in an indication from the first UE 115-g that the second UE 115-h has one or more logged idle-mode measurements. The measurement report may include values associated with measurements, UE positioning, or both, as full values or as difference values from a particular reported value, as discussed herein.

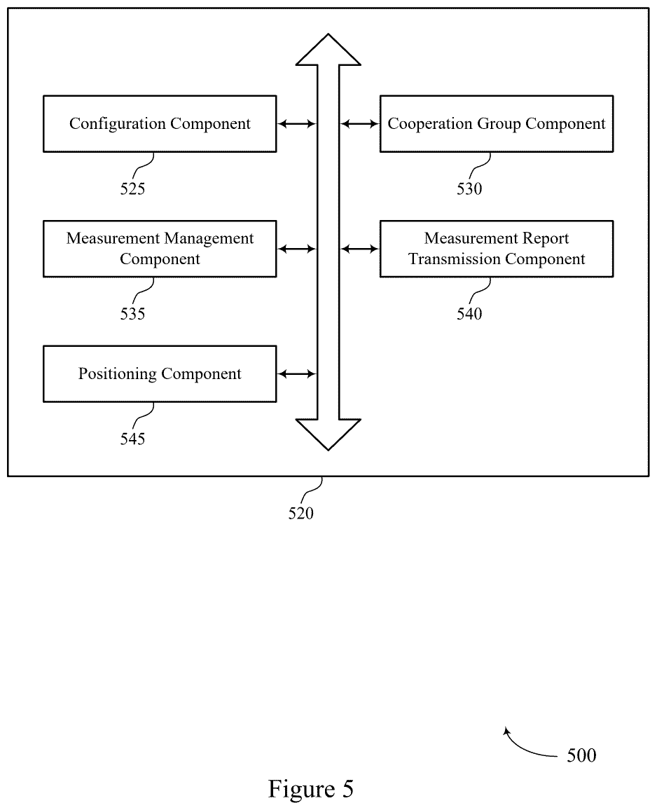

FIG. 5 shows an example of a processing system 520 that supports UE cooperation for idle-mode measurements. A processing system 520 may be an example of a processing system 140 (such as of a UE 115) and may include a configuration component 525, a cooperation group component 530, a measurement management component 535, a measurement report transmission component 540, a positioning component 545, or any combination thereof. A processing system 520, or various component thereof, may be an example of means for performing (such as a means for causing a UE 115 to perform) various techniques described herein.

The configuration component 525 may be configured to cause the UE 115 to receive a measurement configuration for one or more idle mode measurements, the measurement configuration indicating one or more measurement parameters for the one or more idle mode measurements. The cooperation group component 530 may be configured to cause the UE 115 to communicate with one or more UEs of a set of multiple cooperating UEs to identify at least a second UE of the set of multiple cooperating UEs that will perform one or more of logging idle mode measurements or reporting idle mode measurements. The measurement management component 535 may be configured to cause the UE 115 to determine, based on the measurement configuration and the communication with the one or more UEs, to measure one or more instances of the one or more idle mode measurements, report one or more idle mode measurements of the second UE, or both.

In some examples, the measurement management component 535 may be configured to cause the UE 115 to determine to perform a subset of idle mode measurements of a set of two or more idle mode measurements indicated in the measurement configuration. In some examples, the measurement management component 535 may be configured to cause the UE 115 to measure one or more parameters associated with the subset of idle mode measurements.

In some examples, the cooperation group component 530 may be configured to cause the UE 115 to exchange one or more messages with at least the second UE to determine which of the one or more idle mode measurements are to be performed at the first UE and which of the one or more idle mode measurements are to be performed at the second UE.

In some examples, the cooperation group component 530 may be configured to cause the UE 115 to transmit a message to the second UE that delegates at least a first idle mode measurement of the one or more idle mode measurements to the second UE. In some examples, the measurement management component 535 may be configured to cause the UE 115 to receive an indication of one or more measurement values from the second UE that are associated with the first idle mode measurement. In some examples, the measurement report transmission component 540 may be configured to cause the UE 115 to report the one or more measurement values from the second UE to a network entity.

In some examples, to support measuring one or more instances of the one or more idle mode measurements, the measurement management component 535 may be configured to cause the UE 115 to measure one or more values associated with the one or more idle mode measurements. In some examples, to support measuring one or more instances of the one or more idle mode measurements, the measurement management component 535 may be configured to cause the UE 115 to transmit the one or more values to the second UE for reporting to a network entity.

In some examples, the measurement management component 535 may be configured to cause the UE 115 to measure one or more first values associated with the one or more idle mode measurements. In some examples, the measurement management component 535 may be configured to cause the UE 115 to transmit the one or more first values to the second UE for storage. In some examples, the measurement management component 535 may be configured to cause the UE 115 to measure one or more second values associated with the one or more idle mode measurements. In some examples, the measurement management component 535 may be configured to cause the UE 115 to retrieve the one or more first values from the second UE. In some examples, the measurement report transmission component 540 may be configured to cause the UE 115 to transmit a measurement report that includes the one or more first values and the one or more second values.

In some examples, the positioning component 545 may be configured to cause the UE 115 to receive positioning information from the second UE. In some examples, the positioning component 545 may be configured to cause the UE 115 to determine a position associated with the first UE based on the positioning information from the second UE.

In some examples, the measurement report transmission component 540 may be configured to cause the UE 115 to transmit a measurement report that includes the one or more idle mode measurements of the second UE and an indication of which UE of the set of multiple cooperating UEs performed the one or more idle mode measurements.

In some examples, the measurement configuration further indicates whether the first UE can use information from one or more other UEs of the set of multiple cooperating UEs to provide the one or more idle mode measurements.

In some examples, the measurement configuration further indicates which UE of the set of multiple cooperating UEs is to provide each idle mode measurement of the one or more idle mode measurements.

In some examples, the measurement configuration is a group common configuration that is provided to each UE of the set of multiple cooperating UEs.

In some examples, the measurement configuration is a group-aware configuration provided to the first UE, and where the first UE provides the group-aware configuration to other UEs of the set of multiple cooperating UEs.

In some examples, each UE of the set of multiple cooperating UEs performs the one or more idle mode measurements at a different time within a time window.

In some examples, the measurement configuration further indicates one or more thresholds for performing the one or more idle mode measurements, and each UE of the set of multiple cooperating UEs performs the one or more idle mode measurements in accordance with whether the one or more thresholds are met.

In some examples, the measurement configuration further indicates that one or more measurement statistics are to be provided in a measurement report, and a measurement report that indicates the one or more idle mode measurements includes the one or more measurement statistics.

In some examples, the cooperation group component 530 may be configured to cause the UE 115 to select the second UE to perform a first measurement of the one or more idle mode measurements based on the second UE having a more favorable channel condition associated with the first measurement.

In some examples, the measurement management component 535 may be configured to cause the UE 115 to perform, responsive to a determination that a collaboration condition of the set of multiple cooperating UEs is not satisfied, one or more idle mode measurements in accordance with a UE-specific measurement configuration, where the UE-specific measurement configuration is provided with the measurement configuration or obtained in accordance with a re-registration with a network entity subsequent to the determination that the collaboration condition is not satisfied.

In some examples, the measurement configuration indicates one or more different types of reporting for the one or more idle mode measurements of two or more UEs of the set of multiple cooperating UEs, the one or more different types of reporting including one or more of a combined report of measurements, a combined statistics report, a delta measurement report, or a report of an availability of measurements at a different UE of the set of multiple cooperating UEs.

In some examples, the measurement configuration further indicates an accuracy threshold for positioning or localization information, and UEs of the set of multiple cooperating UEs can use positioning or localization information of other UEs of the set of multiple cooperating UEs that are within the accuracy threshold.

In some examples, a measurement report that indicates the one or more idle mode measurements of the set of multiple cooperating UEs includes positioning information associated with at least the first UE associated with a first measurement and the second UE associated with a second measurement, and where first positioning information of the first UE indicates an absolute position and second positioning information of the second UE indicates a difference from the first positioning information.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for obtaining assistance from one or more other UEs of a group of cooperating UEs for logging, reporting, or both, of idle-mode measurements, which may reduce overhead associated with multiple reports from multiple UEs, reduce power consumption and usage of processing resources at UEs, reduce storage associated with idle-mode measurements at UEs, and allow for efficient configuration and reporting of idle-mode measurements across multiple UEs thereby enhancing network efficiency.

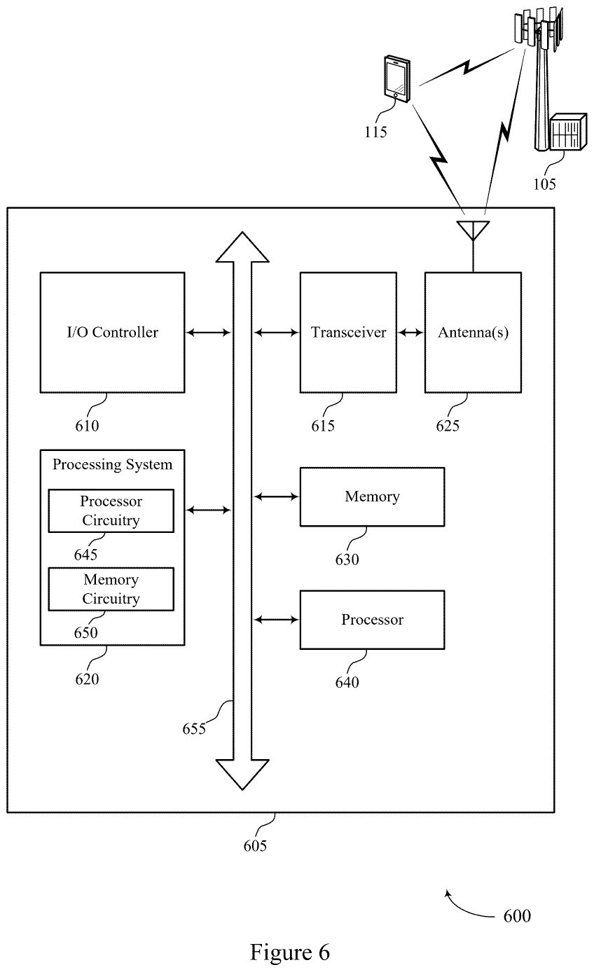

FIG. 6 shows an example of a system 600 including a device 605 that supports UE cooperation for idle-mode measurements. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 500. For example, the processing system 620 may include processor circuitry 645 and memory circuitry 650 that stores code, and may be configured to cause the device 605 to perform operations that support techniques for UE cooperation for idle-mode measurements. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for obtaining assistance from one or more other UEs of a group of cooperating UEs for logging, reporting, or both, of idle-mode measurements, which may reduce overhead associated with multiple reports from multiple UEs, reduce power consumption and usage of processing resources at UEs, reduce storage associated with idle-mode measurements at UEs, and allow for efficient configuration and reporting of idle-mode measurements across multiple UEs thereby enhancing network efficiency.

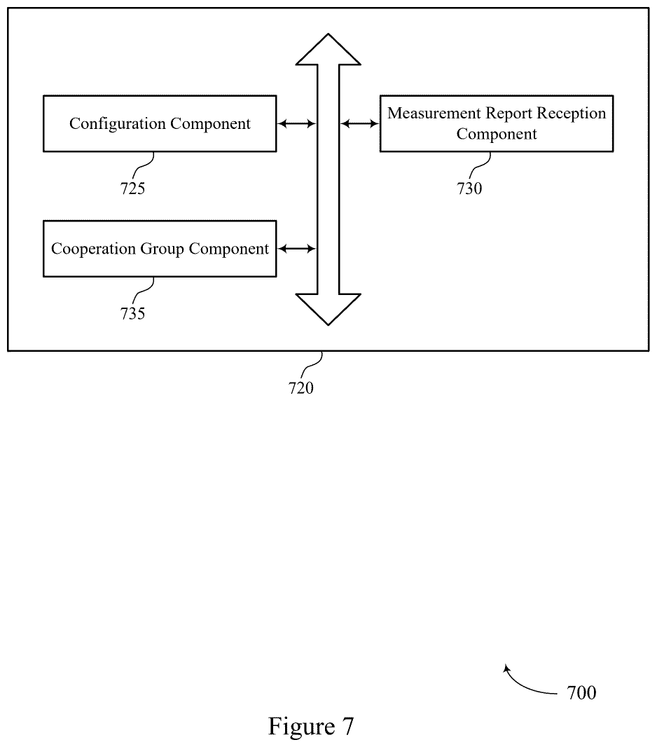

FIG. 7 shows an example of a processing system 720 that supports UE cooperation for idle-mode measurements. A processing system 720 may be an example of a processing system 145 (such as network entity 105) and may include a configuration component 725, a measurement report reception component 730, a cooperation group component 735, or any combination thereof. A processing system 720, or various component thereof, may be an example of means for performing (such as a means for causing a network entity 105 to perform) various techniques described herein.

The configuration component 725 may be configured to cause the network entity 105 to transmit, to at least a first UE of a set of multiple cooperating UEs, a measurement configuration for one or more idle mode measurements, the measurement configuration indicating one or more measurement parameters for the one or more idle mode measurements and one or more UEs of the set of multiple cooperating UEs that are to perform the one or more idle mode measurements. The measurement report reception component 730 may be configured to cause the network entity 105 to receive one or more measurement reports from one or more UEs of the set of multiple cooperating UEs in accordance with the measurement configuration.

In some examples, the one or more measurement reports include the one or more idle mode measurements of the set of multiple cooperating UEs and an indication of which UE of the set of multiple cooperating UEs performed the one or more idle mode measurements. In some examples, the measurement configuration further indicates whether the first UE can use information from one or more other UEs of the set of multiple cooperating UEs to provide the one or more idle mode measurements.

In some examples, the measurement configuration further indicates which UE of the set of multiple cooperating UEs is to provide each idle mode measurement of the one or more idle mode measurements. In some examples, the measurement configuration is a group common configuration that is provided to each UE of the set of multiple cooperating UEs. In some examples, the measurement configuration is a group-aware configuration provided to the first UE, and where the first UE provides the group-aware configuration to other UEs of the set of multiple cooperating UEs.

In some examples, each UE of the set of multiple cooperating UEs performs the one or more idle mode measurements at a different time within a time window. In some examples, the measurement configuration further indicates one or more thresholds for performing the one or more idle mode measurements, and each UE of the set of multiple cooperating UEs performs the one or more idle mode measurements in accordance with whether the one or more thresholds are met. In some examples, the measurement configuration further indicates that one or more measurement statistics are to be provided in a measurement report, and the measurement report includes the one or more measurement statistics.

In some examples, the measurement configuration further indicates a UE-specific measurement configuration that is to be used responsive to a determination that a collaboration condition of the set of multiple cooperating UEs is not satisfied. In some examples, the measurement configuration indicates one or more different types of reporting for the one or more idle mode measurements of two or more UEs of the set of multiple cooperating UEs, the one or more different types of reporting including one or more of a combined report of measurements, a combined statistics report, a delta measurement report, or a report of an availability of measurements at a different UE of the set of multiple cooperating UEs.

In some examples, the measurement configuration further indicates an accuracy threshold for positioning or localization information, and UEs of the set of multiple cooperating UEs can use positioning or localization information of other UEs of the set of multiple cooperating UEs that are within the accuracy threshold. In some examples, the one or more measurement reports include positioning information associated with at least the first UE associated with a first measurement and a second UE associated with a second measurement, and where first positioning information of the first UE indicates an absolute position and second positioning information of the second UE indicates a difference from the first positioning information.

A processing system 720 may include or be an example of one or more chips, SoCs, chipsets, packages, components, or devices that individually or collectively constitute or include a processing system. A processing system 720 may interface with other components of a network entity 105. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a network entity 105). Operations described herein with reference to the processing system 720, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 720 for operation in a processing system 720 as described herein, the processing system 720 may support techniques for obtaining assistance from one or more other UEs of a group of cooperating UEs for logging, reporting, or both, of idle-mode measurements, which may reduce overhead associated with multiple reports from multiple UEs, reduce power consumption and usage of processing resources at UEs, reduce storage associated with idle-mode measurements at UEs, and allow for efficient configuration and reporting of idle-mode measurements across multiple UEs thereby enhancing network efficiency.

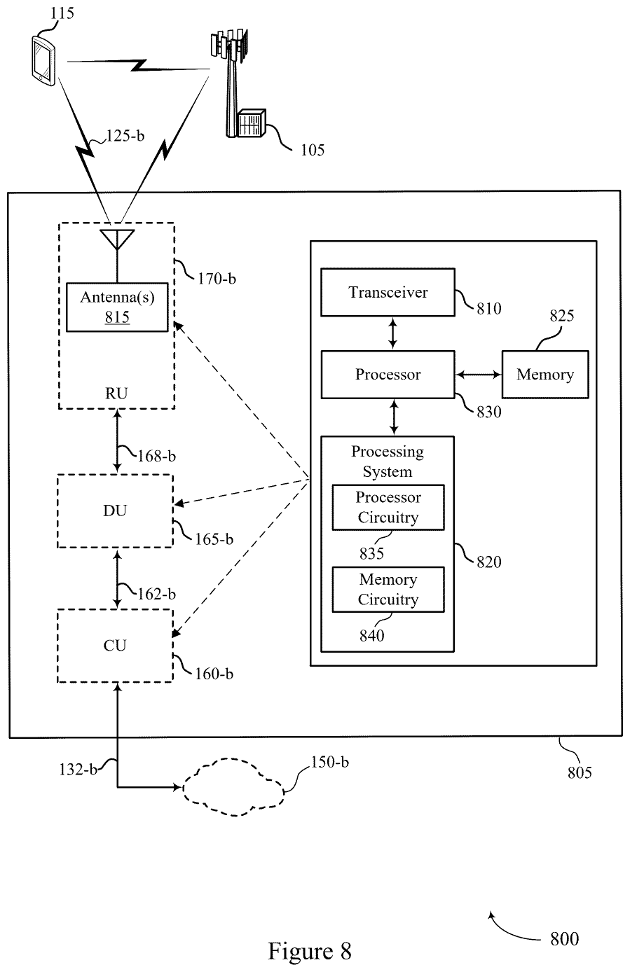

FIG. 8 shows an example of a system 800 including a device 805 that supports UE cooperation for idle-mode measurements. The device 805 may communicate (such as via one or more wired interfaces or one or more wireless interfaces) with other network devices or network equipment such as a core network 150-b, other network entities 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or both, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed by the processor 830, cause the device 805 to perform various functions (such as to support an application of the device 805).

For examples in which the device 805 is a network entity 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network entities 105 and may include a controller or scheduler for controlling communication with UEs 115 (such as in cooperation with the one or more other network entities 105). In some examples, the processing system 820 may support an interface (such as X2 interface, Xn interface) to provide communication between network entities 105.

The processing system 820 may be an example of a processing system 145 or a processing system 700. For example, the processing system 820 may include processor circuitry 835 and memory circuitry 840 that stores code, and the processing system 820 may be configured to cause the device 805 to perform operations that support techniques for UE cooperation for idle-mode measurements. Although the processing system 820 is illustrated as a separate component, which may involve a separate chip, chipset, or other module, in some implementations, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, may support techniques for obtaining assistance from one or more other UEs of a group of cooperating UEs for logging, reporting, or both, of idle-mode measurements, which may reduce overhead associated with multiple reports from multiple UEs, reduce power consumption and usage of processing resources at UEs, reduce storage associated with idle-mode measurements at UEs, and allow for efficient configuration and reporting of idle-mode measurements across multiple UEs thereby enhancing network efficiency.

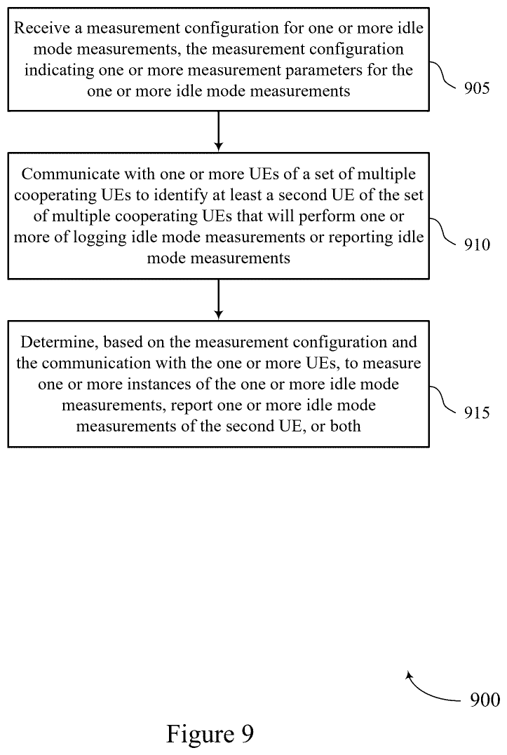

FIG. 9 shows an example of a method 900 that supports UE cooperation for idle-mode measurements. Operations of the method 900 may be performed by a UE or its components (such as using a processing system configured to cause the UE 115 to perform one or more of the operations) as described herein.

At 905, the method may include receiving a measurement configuration for one or more idle mode measurements, the measurement configuration indicating one or more measurement parameters for the one or more idle mode measurements. In some examples, aspects of the operations of 905 may be performed by a configuration component 525.

At 910, the method may include communicating with one or more UEs of a set of multiple cooperating UEs to identify at least a second UE of the set of multiple cooperating UEs that will perform one or more of logging idle mode measurements or reporting idle mode measurements. In some examples, aspects of the operations of 910 may be performed by a cooperation group component 530.

At 915, the method may include determining, based on the measurement configuration and the communication with the one or more UEs, to measure one or more instances of the one or more idle mode measurements, report one or more idle mode measurements of the second UE, or both. In some examples, aspects of the operations of 915 may be performed by a measurement management component 535.

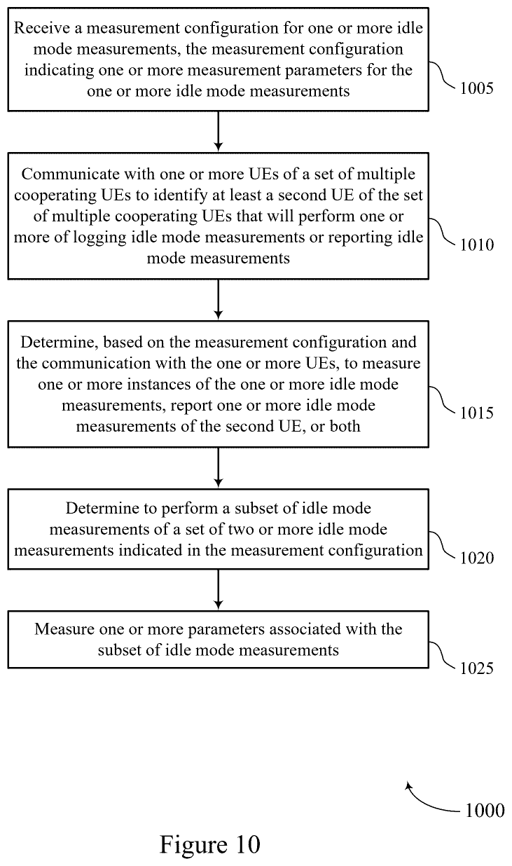

FIG. 10 shows an example of a method 1000 that supports UE cooperation for idle-mode measurements. Operations of the method 1000 may be performed by a UE or its components (such as using a processing system configured to cause the UE 115 to perform one or more of the operations) as described herein.

At 1005, the method may include receiving a measurement configuration for one or more idle mode measurements, the measurement configuration indicating one or more measurement parameters for the one or more idle mode measurements. In some examples, aspects of the operations of 1005 may be performed by a configuration component 525.

At 1010, the method may include communicating with one or more UEs of a set of multiple cooperating UEs to identify at least a second UE of the set of multiple cooperating UEs that will perform one or more of logging idle mode measurements or reporting idle mode measurements. In some examples, aspects of the operations of 1010 may be performed by a cooperation group component 530.

At 1015, the method may include determining, based on the measurement configuration and the communication with the one or more UEs, to measure one or more instances of the one or more idle mode measurements, report one or more idle mode measurements of the second UE, or both. In some examples, aspects of the operations of 1015 may be performed by a measurement management component 535.

At 1020, the method may include determining to perform a subset of idle mode measurements of a set of two or more idle mode measurements indicated in the measurement configuration. In some examples, aspects of the operations of 1020 may be performed by a measurement management component 535.

At 1025, the method may include measuring one or more parameters associated with the subset of idle mode measurements. In some examples, aspects of the operations of 1025 may be performed by a measurement management component 535.

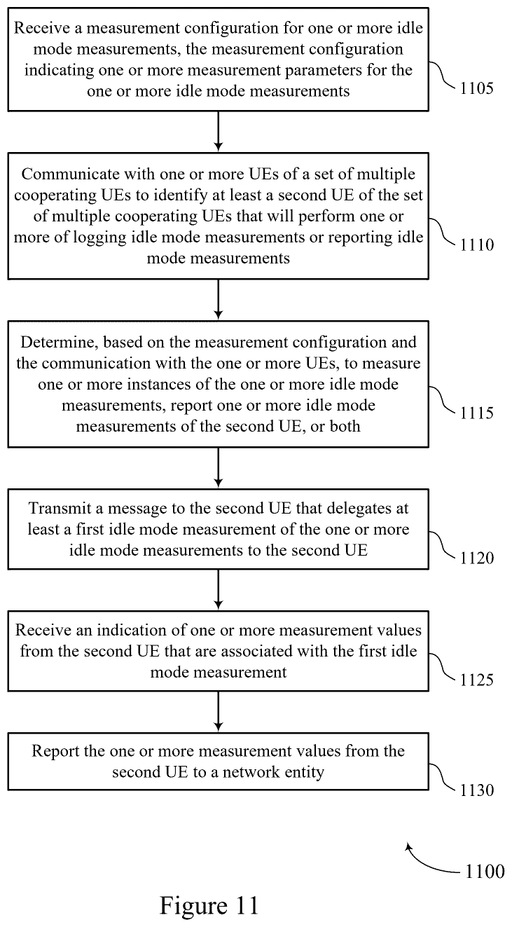

FIG. 11 shows an example of a method 1100 that supports UE cooperation for idle-mode measurements. Operations of the method 1100 may be performed by a UE or its components (such as using a processing system configured to cause the UE 115 to perform one or more of the operations) as described herein.

At 1105, the method may include receiving a measurement configuration for one or more idle mode measurements, the measurement configuration indicating one or more measurement parameters for the one or more idle mode measurements. In some examples, aspects of the operations of 1105 may be performed by a configuration component 525.

At 1110, the method may include communicating with one or more UEs of a set of multiple cooperating UEs to identify at least a second UE of the set of multiple cooperating UEs that will perform one or more of logging idle mode measurements or reporting idle mode measurements. In some examples, aspects of the operations of 1110 may be performed by a cooperation group component 530.

At 1115, the method may include determining, based on the measurement configuration and the communication with the one or more UEs, to measure one or more instances of the one or more idle mode measurements, report one or more idle mode measurements of the second UE, or both. In some examples, aspects of the operations of 1115 may be performed by a measurement management component 535.

At 1120, the method may include transmitting a message to the second UE that delegates at least a first idle mode measurement of the one or more idle mode measurements to the second UE. In some examples, aspects of the operations of 1120 may be performed by a cooperation group component 530.

At 1125, the method may include receiving an indication of one or more measurement values from the second UE that are associated with the first idle mode measurement. In some examples, aspects of the operations of 1125 may be performed by a measurement management component 535.

At 1130, the method may include reporting the one or more measurement values from the second UE to a network entity. In some examples, aspects of the operations of 1130 may be performed by a measurement report transmission component 540.

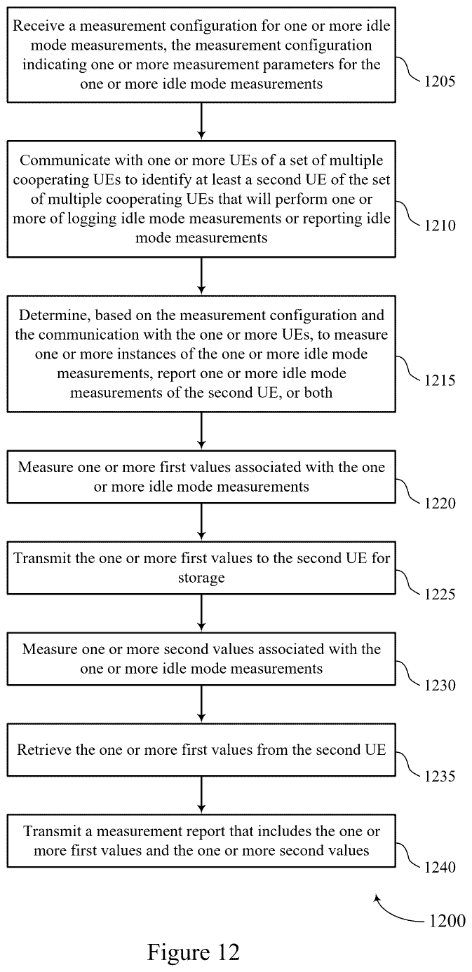

FIG. 12 shows an example of a method 1200 that supports UE cooperation for idle-mode measurements. Operations of the method 1200 may be performed by a UE or its components (such as using a processing system configured to cause the UE 115 to perform one or more of the operations) as described herein.

At 1205, the method may include receiving a measurement configuration for one or more idle mode measurements, the measurement configuration indicating one or more measurement parameters for the one or more idle mode measurements. In some examples, aspects of the operations of 1205 may be performed by a configuration component 525.

At 1210, the method may include communicating with one or more UEs of a set of multiple cooperating UEs to identify at least a second UE of the set of multiple cooperating UEs that will perform one or more of logging idle mode measurements or reporting idle mode measurements. In some examples, aspects of the operations of 1210 may be performed by a cooperation group component 530.

At 1215, the method may include determining, based on the measurement configuration and the communication with the one or more UEs, to measure one or more instances of the one or more idle mode measurements, report one or more idle mode measurements of the second UE, or both. In some examples, aspects of the operations of 1215 may be performed by a measurement management component 535.

At 1220, the method may include measuring one or more first values associated with the one or more idle mode measurements. In some examples, aspects of the operations of 1220 may be performed by a measurement management component 535.

At 1225, the method may include transmitting the one or more first values to the second UE for storage. In some examples, aspects of the operations of 1225 may be performed by a measurement management component 535.

At 1230, the method may include measuring one or more second values associated with the one or more idle mode measurements. In some examples, aspects of the operations of 1230 may be performed by a measurement management component 535.

At 1235, the method may include retrieving the one or more first values from the second UE. In some examples, aspects of the operations of 1235 may be performed by a measurement management component 535.

At 1240, the method may include transmitting a measurement report that includes the one or more first values and the one or more second values. In some examples, aspects of the operations of 1240 may be performed by a measurement report transmission component 540.

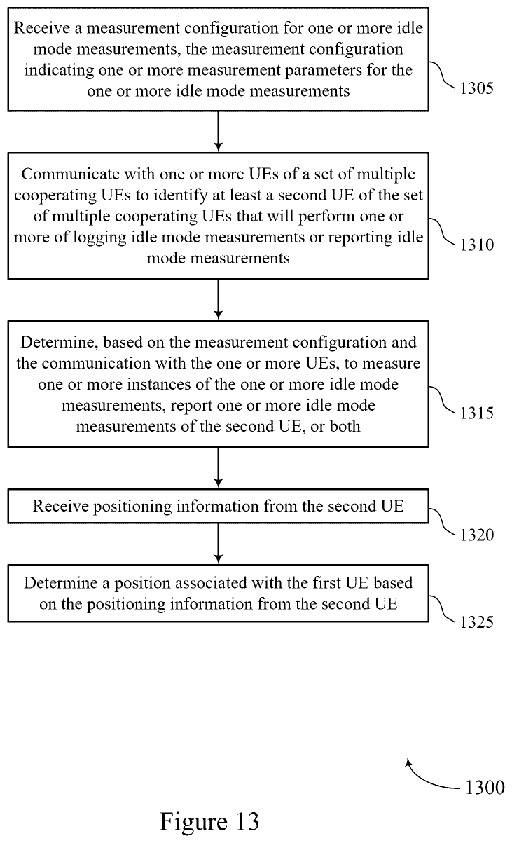

FIG. 13 shows an example of a method 1300 that supports UE cooperation for idle-mode measurements. Operations of the method 1300 may be performed by a UE or its components (such as using a processing system configured to cause the UE 115 to perform one or more of the operations) as described herein.

At 1305, the method may include receiving a measurement configuration for one or more idle mode measurements, the measurement configuration indicating one or more measurement parameters for the one or more idle mode measurements. In some examples, aspects of the operations of 1305 may be performed by a configuration component 525.

At 1310, the method may include communicating with one or more UEs of a set of multiple cooperating UEs to identify at least a second UE of the set of multiple cooperating UEs that will perform one or more of logging idle mode measurements or reporting idle mode measurements. In some examples, aspects of the operations of 1310 may be performed by a cooperation group component 530.

At 1315, the method may include determining, based on the measurement configuration and the communication with the one or more UEs, to measure one or more instances of the one or more idle mode measurements, report one or more idle mode measurements of the second UE, or both. In some examples, aspects of the operations of 1315 may be performed by a measurement management component 535.

At 1320, the method may include receiving positioning information from the second UE. In some examples, aspects of the operations of 1320 may be performed by a positioning component 545.

At 1325, the method may include determining a position associated with the first UE based on the positioning information from the second UE. In some examples, aspects of the operations of 1325 may be performed by a positioning component 545.

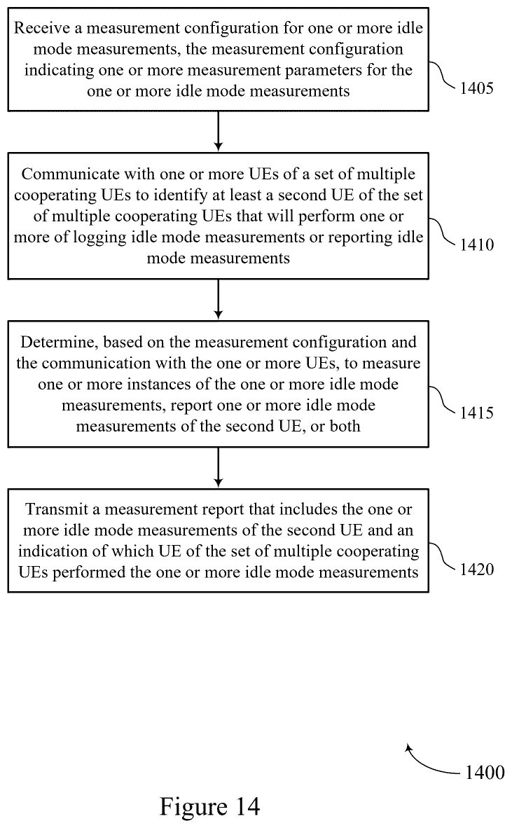

FIG. 14 shows an example of a method 1400 that supports UE cooperation for idle-mode measurements. Operations of the method 1400 may be performed by a UE or its components (such as using a processing system configured to cause the UE 115 to perform one or more of the operations) as described herein.

At 1405, the method may include receiving a measurement configuration for one or more idle mode measurements, the measurement configuration indicating one or more measurement parameters for the one or more idle mode measurements. In some examples, aspects of the operations of 1405 may be performed by a configuration component 525.

At 1410, the method may include communicating with one or more UEs of a set of multiple cooperating UEs to identify at least a second UE of the set of multiple cooperating UEs that will perform one or more of logging idle mode measurements or reporting idle mode measurements. In some examples, aspects of the operations of 1410 may be performed by a cooperation group component 530.

At 1415, the method may include determining, based on the measurement configuration and the communication with the one or more UEs, to measure one or more instances of the one or more idle mode measurements, report one or more idle mode measurements of the second UE, or both. In some examples, aspects of the operations of 1415 may be performed by a measurement management component 535.

At 1420, the method may include transmitting a measurement report that includes the one or more idle mode measurements of the second UE and an indication of which UE of the set of multiple cooperating UEs performed the one or more idle mode measurements. In some examples, aspects of the operations of 1420 may be performed by a measurement report transmission component 540.

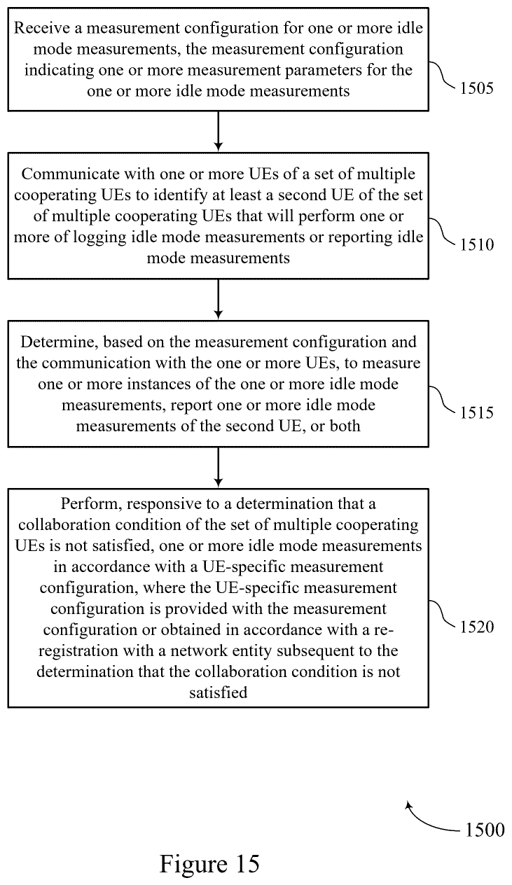

FIG. 15 shows an example of a method 1500 that supports UE cooperation for idle-mode measurements. Operations of the method 1500 may be performed by a UE or its components (such as using a processing system configured to cause the UE 115 to perform one or more of the operations) as described herein.

At 1505, the method may include receiving a measurement configuration for one or more idle mode measurements, the measurement configuration indicating one or more measurement parameters for the one or more idle mode measurements. In some examples, aspects of the operations of 1505 may be performed by a configuration component 525.

At 1510, the method may include communicating with one or more UEs of a set of multiple cooperating UEs to identify at least a second UE of the set of multiple cooperating UEs that will perform one or more of logging idle mode measurements or reporting idle mode measurements. In some examples, aspects of the operations of 1510 may be performed by a cooperation group component 530.

At 1515, the method may include determining, based on the measurement configuration and the communication with the one or more UEs, to measure one or more instances of the one or more idle mode measurements, report one or more idle mode measurements of the second UE, or both. In some examples, aspects of the operations of 1515 may be performed by a measurement management component 535.

At 1520, the method may include performing, responsive to a determination that a collaboration condition of the set of multiple cooperating UEs is not satisfied, one or more idle mode measurements in accordance with a UE-specific measurement configuration, where the UE-specific measurement configuration is provided with the measurement configuration or obtained in accordance with a re-registration with a network entity subsequent to the determination that the collaboration condition is not satisfied. In some examples, aspects of the operations of 1520 may be performed by a measurement management component 535.

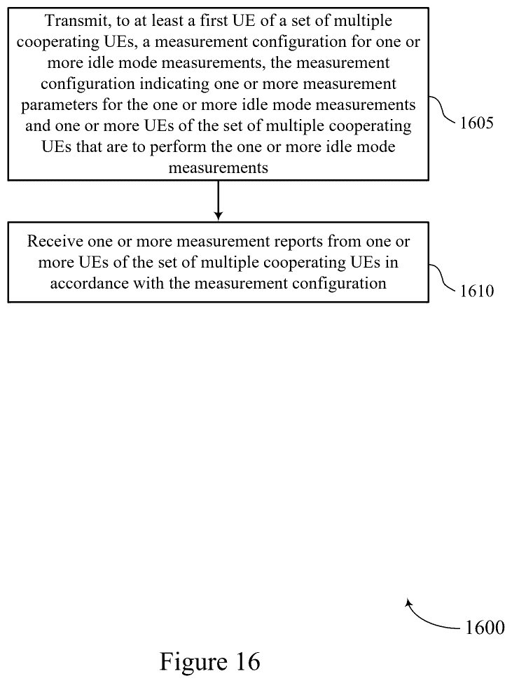

FIG. 16 shows an example of a method 1600 that supports UE cooperation for idle-mode measurements. Operations of the method 1600 may be performed by a network entity 105 or its components (such as using a processing system configured to cause the network entity to perform one or more operations) as described herein.

At 1605, the method may include transmitting, to at least a first UE of a set of multiple cooperating UEs, a measurement configuration for one or more idle mode measurements, the measurement configuration indicating one or more measurement parameters for the one or more idle mode measurements and one or more UEs of the set of multiple cooperating UEs that are to perform the one or more idle mode measurements. In some examples, aspects of the operations of 1605 may be performed by a configuration component 725.

At 1610, the method may include receiving one or more measurement reports from one or more UEs of the set of multiple cooperating UEs in accordance with the measurement configuration. In some examples, aspects of the operations of 1610 may be performed by a measurement report reception component 730.

Implementation examples are described in the following numbered clauses:

Aspect 1: A method for wireless communications at a first UE, comprising: receiving a measurement configuration for one or more idle mode measurements, the measurement configuration indicating one or more measurement parameters for the one or more idle mode measurements; communicating with one or more UEs of a plurality of cooperating UEs to identify at least a second UE of the plurality of cooperating UEs that will perform one or more of logging idle mode measurements or reporting idle mode measurements; and determining, based at least in part on the measurement configuration and the communication with the one or more UEs, to measure one or more instances of the one or more idle mode measurements, report one or more idle mode measurements of the second UE, or both.

Aspect 2: The method of aspect 1, further comprising: determining to perform a subset of idle mode measurements of a set of two or more idle mode measurements indicated in the measurement configuration; and measuring one or more parameters associated with the subset of idle mode measurements.

Aspect 3: The method of any of aspects 1 through 2, further comprising: exchanging one or more messages with at least the second UE to determine which of the one or more idle mode measurements are to be performed at the first UE and which of the one or more idle mode measurements are to be performed at the second UE.

Aspect 4: The method of any of aspects 1 through 3, further comprising: transmitting a message to the second UE that delegates at least a first idle mode measurement of the one or more idle mode measurements to the second UE; receiving an indication of one or more measurement values from the second UE that are associated with the first idle mode measurement; and reporting the one or more measurement values from the second UE to a network entity.

Aspect 5: The method of any of aspects 1 through 4, wherein the measuring one or more instances of the one or more idle mode measurements comprises: measuring one or more values associated with the one or more idle mode measurements; and transmitting the one or more values to the second UE for reporting to a network entity.

Aspect 6: The method of any of aspects 1 through 5, further comprising: measuring one or more first values associated with the one or more idle mode measurements; transmitting the one or more first values to the second UE for storage; measuring one or more second values associated with the one or more idle mode measurements; retrieving the one or more first values from the second UE; and transmitting a measurement report that includes the one or more first values and the one or more second values.

Aspect 7: The method of any of aspects 1 through 6, further comprising: receiving positioning information from the second UE; and determining a position associated with the first UE based at least in part on the positioning information from the second UE.

Aspect 8: The method of any of aspects 1 through 7, further comprising: transmitting a measurement report that includes the one or more idle mode measurements of the second UE and an indication of which UE of the plurality of cooperating UEs performed the one or more idle mode measurements.

Aspect 9: The method of any of aspects 1 through 8, wherein the measurement configuration further indicates whether the first UE can use information from one or more other UEs of the plurality of cooperating UEs to provide the one or more idle mode measurements.

Aspect 10: The method of any of aspects 1 through 9, wherein the measurement configuration further indicates which UE of the plurality of cooperating UEs is to provide each idle mode measurement of the one or more idle mode measurements.

Aspect 11: The method of aspect 10, wherein the measurement configuration is a group common configuration that is provided to each UE of the plurality of cooperating UEs.

Aspect 12: The method of any of aspects 10 through 11, wherein the measurement configuration is a group-aware configuration provided to the first UE, and wherein the first UE provides the group-aware configuration to other UEs of the plurality of cooperating UEs.

Aspect 13: The method of any of aspects 1 through 12, wherein each UE of the plurality of cooperating UEs performs the one or more idle mode measurements at a different time within a time window.

Aspect 14: The method of any of aspects 1 through 13, wherein the measurement configuration further indicates one or more thresholds for performing the one or more idle mode measurements, and each UE of the plurality of cooperating UEs performs the one or more idle mode measurements in accordance with whether the one or more thresholds are met.

Aspect 15: The method of any of aspects 1 through 14, wherein the measurement configuration further indicates that one or more measurement statistics are to be provided in a measurement report, and a measurement report that indicates the one or more idle mode measurements includes the one or more measurement statistics.

Aspect 16: The method of any of aspects 1 through 15, further comprising: selecting the second UE to perform a first measurement of the one or more idle mode measurements based at least in part on the second UE having a more favorable channel condition associated with the first measurement.

Aspect 17: The method of any of aspects 1 through 16, further comprising: performing, responsive to a determination that a collaboration condition of the plurality of cooperating UEs is not satisfied, one or more idle mode measurements in accordance with a UE-specific measurement configuration, wherein the UE-specific measurement configuration is provided with the measurement configuration or obtained in accordance with a re-registration with a network entity subsequent to the determination that the collaboration condition is not satisfied.

Aspect 18: The method of any of aspects 1 through 17, wherein the measurement configuration indicates one or more different types of reporting for the one or more idle mode measurements of two or more UEs of the plurality of cooperating UEs, the one or more different types of reporting including one or more of a combined report of measurements, a combined statistics report, a delta measurement report, or a report of an availability of measurements at a different UE of the plurality of cooperating UEs.

Aspect 19: The method of any of aspects 1 through 18, wherein the measurement configuration further indicates an accuracy threshold for positioning or localization information, and UEs of the plurality of cooperating UEs can use positioning or localization information of other UEs of the plurality of cooperating UEs that are within the accuracy threshold.

Aspect 20: The method of any of aspects 1 through 19, wherein a measurement report that indicates the one or more idle mode measurements of the plurality of cooperating UEs includes positioning information associated with at least the first UE associated with a first measurement and the second UE associated with a second measurement, and wherein first positioning information of the first UE indicates an absolute position and second positioning information of the second UE indicates a difference from the first positioning information.

Aspect 21: A method for wireless communications at a network entity, comprising: transmitting, to at least a first UE of a plurality of cooperating UEs, a measurement configuration for one or more idle mode measurements, the measurement configuration indicating one or more measurement parameters for the one or more idle mode measurements and one or more UEs of the plurality of cooperating UEs that are to perform the one or more idle mode measurements; and receiving one or more measurement reports from one or more UEs of the plurality of cooperating UEs in accordance with the measurement configuration.

Aspect 22: The method of aspect 21, wherein the one or more measurement reports include the one or more idle mode measurements of the plurality of cooperating UEs and an indication of which UE of the plurality of cooperating UEs performed the one or more idle mode measurements.

Aspect 23: The method of any of aspects 21 through 22, wherein the measurement configuration further indicates whether the first UE can use information from one or more other UEs of the plurality of cooperating UEs to provide the one or more idle mode measurements.

Aspect 24: The method of any of aspects 21 through 23, wherein the measurement configuration further indicates which UE of the plurality of cooperating UEs is to provide each idle mode measurement of the one or more idle mode measurements.

Aspect 25: The method of aspect 24, wherein the measurement configuration is a group common configuration that is provided to each UE of the plurality of cooperating UEs.

Aspect 26: The method of any of aspects 24 through 25, wherein the measurement configuration is a group-aware configuration provided to the first UE, and wherein the first UE provides the group-aware configuration to other UEs of the plurality of cooperating UEs.

Aspect 27: The method of any of aspects 21 through 26, wherein each UE of the plurality of cooperating UEs performs the one or more idle mode measurements at a different time within a time window.

Aspect 28: The method of any of aspects 21 through 27, wherein the measurement configuration further indicates one or more thresholds for performing the one or more idle mode measurements, and each UE of the plurality of cooperating UEs performs the one or more idle mode measurements in accordance with whether the one or more thresholds are met.

Aspect 29: The method of any of aspects 21 through 28, wherein the measurement configuration further indicates that one or more measurement statistics are to be provided in a measurement report, and the measurement report includes the one or more measurement statistics.

Aspect 30: The method of any of aspects 21 through 29, wherein the measurement configuration further indicates a UE-specific measurement configuration that is to be used responsive to a determination that a collaboration condition of the plurality of cooperating UEs is not satisfied.

Aspect 31: The method of any of aspects 21 through 30, wherein the measurement configuration indicates one or more different types of reporting for the one or more idle mode measurements of two or more UEs of the plurality of cooperating UEs, the one or more different types of reporting including one or more of a combined report of measurements, a combined statistics report, a delta measurement report, or a report of an availability of measurements at a different UE of the plurality of cooperating UEs.

Aspect 32: The method of any of aspects 21 through 31, wherein the measurement configuration further indicates an accuracy threshold for positioning or localization information, and UEs of the plurality of cooperating UEs can use positioning or localization information of other UEs of the plurality of cooperating UEs that are within the accuracy threshold.

Aspect 33: The method of any of aspects 21 through 32, wherein the one or more measurement reports include positioning information associated with at least the first UE associated with a first measurement and a second UE associated with a second measurement, and wherein first positioning information of the first UE indicates an absolute position and second positioning information of the second UE indicates a difference from the first positioning information.

Aspect 34: A first UE for wireless communications, comprising a processing system that includes processor circuitry and memory circuitry that stores code, the processing system configured to cause the first UE to perform a method of any of aspects 1 through 20.

Aspect 35: A first UE for wireless communications, comprising at least one means for performing a method of any of aspects 1 through 20.

Aspect 36: A non-transitory computer-readable medium storing code for wireless communications, the code comprising instructions executable by one or more processors to perform a method of any of aspects 1 through 20.

Aspect 37: A network entity for wireless communications, comprising a processing system that includes processor circuitry and memory circuitry that stores code, the processing system configured to cause the network entity to perform a method of any of aspects 21 through 33.

Aspect 38: A network entity for wireless communications, comprising at least one means for performing a method of any of aspects 21 through 33.

Aspect 39: A non-transitory computer-readable medium storing code for wireless communications, the code comprising instructions executable by one or more processors to perform a method of any of aspects 21 through 33.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
a processing system that includes processor circuitry and memory circuitry that stores code, the processing system configured to cause the first UE to:
receive a measurement configuration for one or more idle mode measurements, the measurement configuration indicating one or more measurement parameters for the one or more idle mode measurements;
communicate with one or more UEs of a plurality of cooperating UEs to identify at least a second UE of the plurality of cooperating UEs that will perform one or more of logging idle mode measurements or reporting idle mode measurements; and
determine, based at least in part on the measurement configuration and the communication with the one or more UEs, to measure one or more instances of the one or more idle mode measurements, report one or more idle mode measurements of the second UE, or both.

2. The first UE of claim 1, wherein the processing system is further configured to cause the first UE to:
determine to perform a subset of idle mode measurements of a set of two or more idle mode measurements indicated in the measurement configuration; and
measure one or more parameters associated with the subset of idle mode measurements.

3. The first UE of claim 1, wherein the processing system is further configured to cause the first UE to:
exchange one or more messages with at least the second UE to determine which of the one or more idle mode measurements are to be performed at the first UE and which of the one or more idle mode measurements are to be performed at the second UE.

4. The first UE of claim 1, wherein the processing system is further configured to cause the first UE to:
transmit a message to the second UE that delegates at least a first idle mode measurement of the one or more idle mode measurements to the second UE;
receive an indication of one or more measurement values from the second UE that are associated with the first idle mode measurement; and
report the one or more measurement values from the second UE to a network entity.

5. The first UE of claim 1, wherein, to the measure one or more instances of the one or more idle mode measurements, the processing system is configured to cause the first UE to:
measure one or more values associated with the one or more idle mode measurements; and
transmit the one or more values to the second UE for reporting to a network entity.

6. The first UE of claim 1, wherein the processing system is further configured to cause the first UE to:
measure one or more first values associated with the one or more idle mode measurements;
transmit the one or more first values to the second UE for storage;
measure one or more second values associated with the one or more idle mode measurements;
retrieve the one or more first values from the second UE; and
transmit a measurement report that includes the one or more first values and the one or more second values.

7. The first UE of claim 1, wherein the processing system is further configured to cause the first UE to:
receive positioning information from the second UE; and
determine a position associated with the first UE based at least in part on the positioning information from the second UE.

8. The first UE of claim 1, wherein the processing system is further configured to cause the first UE to:
transmit a measurement report that includes the one or more idle mode measurements of the second UE and an indication of which UE of the plurality of cooperating UEs performed the one or more idle mode measurements.

9. The first UE of claim 1, wherein the measurement configuration further indicates which UE of the plurality of cooperating UEs is to provide each idle mode measurement of the one or more idle mode measurements.

10. The first UE of claim 1, wherein each UE of the plurality of cooperating UEs performs the one or more idle mode measurements at a different time within a time window.

11. The first UE of claim 1, wherein the measurement configuration further indicates one or more thresholds for performing the one or more idle mode measurements, and each UE of the plurality of cooperating UEs performs the one or more idle mode measurements in accordance with whether the one or more thresholds are met.

12. The first UE of claim 1, wherein the processing system is further configured to cause the first UE to:
perform, responsive to a determination that a collaboration condition of the plurality of cooperating UEs is not satisfied, one or more idle mode measurements in accordance with a UE-specific measurement configuration, wherein the UE-specific measurement configuration is provided with the measurement configuration or obtained in accordance with a re-registration with a network entity subsequent to the determination that the collaboration condition is not satisfied.

13. The first UE of claim 1, wherein the measurement configuration indicates one or more different types of reporting for the one or more idle mode measurements of two or more UEs of the plurality of cooperating UEs, the one or more different types of reporting including one or more of a combined report of measurements, a combined statistics report, a delta measurement report, or a report of an availability of measurements at a different UE of the plurality of cooperating UEs.

14. The first UE of claim 1, wherein a measurement report that indicates the one or more idle mode measurements of the plurality of cooperating UEs includes positioning information associated with at least the first UE associated with a first measurement and the second UE associated with a second measurement, and wherein first positioning information of the first UE indicates an absolute position and second positioning information of the second UE indicates a difference from the first positioning information.

15. A network entity, comprising:
a processing system that includes processor circuitry and memory circuitry that stores code, the processing system configured to cause the network entity to:
transmit, to at least a first user equipment (UE) of a plurality of cooperating UEs, a measurement configuration for one or more idle mode measurements, the measurement configuration indicating one or more measurement parameters for the one or more idle mode measurements and one or more UEs of the plurality of cooperating UEs that are to perform the one or more idle mode measurements; and
receive one or more measurement reports from one or more UEs of the plurality of cooperating UEs in accordance with the measurement configuration.

16. The network entity of claim 15, wherein the one or more measurement reports include the one or more idle mode measurements of the plurality of cooperating UEs and an indication of which UE of the plurality of cooperating UEs performed the one or more idle mode measurements.

17. The network entity of claim 15, wherein the measurement configuration is a group-aware configuration provided to the first UE, and wherein the first UE provides the group-aware configuration to other UEs of the plurality of cooperating UEs.

18. The network entity of claim 15, wherein each UE of the plurality of cooperating UEs performs the one or more idle mode measurements at a different time within a time window.

19. The network entity of claim 15, wherein the measurement configuration further indicates one or more thresholds for performing the one or more idle mode measurements, and each UE of the plurality of cooperating UEs performs the one or more idle mode measurements in accordance with whether the one or more thresholds are met.

20. The network entity of claim 15, wherein the measurement configuration indicates one or more different types of reporting for the one or more idle mode measurements of two or more UEs of the plurality of cooperating UEs, the one or more different types of reporting including one or more of a combined report of measurements, a combined statistics report, a delta measurement report, or a report of an availability of measurements at a different UE of the plurality of cooperating UEs.

21. The network entity of claim 15, wherein the measurement configuration further indicates an accuracy threshold for positioning or localization information, and UEs of the plurality of cooperating UEs can use positioning or localization information of other UEs of the plurality of cooperating UEs that are within the accuracy threshold.

22. A method for wireless communications at a first user equipment (UE), comprising:
receiving a measurement configuration for one or more idle mode measurements, the measurement configuration indicating one or more measurement parameters for the one or more idle mode measurements;
communicating with one or more UEs of a plurality of cooperating UEs to identify at least a second UE of the plurality of cooperating UEs that will perform one or more of logging idle mode measurements or reporting idle mode measurements; and
determining, based at least in part on the measurement configuration and the communication with the one or more UEs, to measure one or more instances of the one or more idle mode measurements, report one or more idle mode measurements of the second UE, or both.

23. The method of claim 22, further comprising:
determining to perform a subset of idle mode measurements of a set of two or more idle mode measurements indicated in the measurement configuration; and
measuring one or more parameters associated with the subset of idle mode measurements.

24. The method of claim 22, further comprising:
exchanging one or more messages with at least the second UE to determine which of the one or more idle mode measurements are to be performed at the first UE and which of the one or more idle mode measurements are to be performed at the second UE.

25. The method of claim 22, wherein the measurement configuration further indicates whether the first UE can use information from one or more other UEs of the plurality of cooperating UEs to provide the one or more idle mode measurements.

26. A method for wireless communications at a network entity, comprising:
transmitting, to at least a first user equipment (UE) of a plurality of cooperating UEs, a measurement configuration for one or more idle mode measurements, the measurement configuration indicating one or more measurement parameters for the one or more idle mode measurements and one or more UEs of the plurality of cooperating UEs that are to perform the one or more idle mode measurements; and
receiving one or more measurement reports from one or more UEs of the plurality of cooperating UEs in accordance with the measurement configuration.

27. The method of claim 26, wherein the one or more measurement reports include the one or more idle mode measurements of the plurality of cooperating UEs and an indication of which UE of the plurality of cooperating UEs performed the one or more idle mode measurements.

28. The method of claim 26, wherein the measurement configuration further indicates whether the first UE can use information from one or more other UEs of the plurality of cooperating UEs to provide the one or more idle mode measurements.

29. The method of claim 26, wherein the measurement configuration further indicates one or more thresholds for performing the one or more idle mode measurements, and each UE of the plurality of cooperating UEs performs the one or more idle mode measurements in accordance with whether the one or more thresholds are met.

30. The method of claim 26, wherein the measurement configuration further indicates a UE-specific measurement configuration that is to be used responsive to a determination that a collaboration condition of the plurality of cooperating UEs is not satisfied.
